(19) United States
(12) Patent Application Publication
(10) Pub. No.: US 2016/0036675 A1
(43) Pub. Date: Feb. 4, 2016

(54) IDENTIFYING A BOTTLENECK IN A DATA TRANSFER

(71) Applicant: LinkedIn Corporation, Mountain View, CA (US)

(72) Inventors: Zhenyun Zhuang, Belmont, CA (US); Haricharan K. Ramachandra, Fremont, CA (US); Badrinath K. Sridharan, Saratoga, CA (US)

(21) Appl. No.: 14/451,090

(22) Filed: Aug. 4, 2014

(51) Int. Cl. H04L 12/26

(52) U.S. Cl. CPC H04L 43/0852; H04L 43/0894

(57) ABSTRACT

A system, methods and apparatus are provided for determining the locus of a bottleneck in a data transfer between a data receiver (e.g., a client device) and a data sender (e.g., a computer server). The locus may be one of a receiver realm encompassing the data receiver (especially a receiver application that consumes the data), a sender realm encompassing the data sender (especially a sender application that produces the data), and a communication link realm that encompasses the communication link(s) over which the data are conveyed (and possibly network-layer protocols and lower that use the communication link(s)). A monitor entity may employ a state-machine model to represent and track progress of a given data transfer between states, using information collected from the data receiver and data sender to identify state transitions. Given a time at which a transfer was delayed or halted, the monitor outputs the locus of the problem.

### BACKGROUND

This disclosure relates to the field of computer systems. More particularly, a system, methods, and apparatus are provided for isolating the locus of a delayed or aborted data transfer between different computing devices.

When a slow data download is detected between a data recipient, such as a client device (e.g., a personal computer, a smart phone), and a data sender, such as a server device (e.g., a web server, a data server), it may take a relatively long time to determine the cause. In addition, multiple engineers or troubleshooters may be involved in trying to find the problem. For example, one engineer familiar with operation of the server may investigate possible issues on the server, while another engineer familiar with operation of client devices investigates possible causes on the client device. Even if only one troubleshooter investigates the problem, unless there are multiple causes of the slow download, at least one of these investigations will be fruitless and therefore a waste of time.

Traditional monitoring tools generally allow a troubleshooter to investigate one specific cause of a slow data transfer at a time, but still require separate considerations of each possible cause. Traditional troubleshooting techniques are also usually hampered by the fact that any of multiple entities (e.g., a server, a client) could be the source of the problem, and that multiple protocol layers are involved in the overall data transfer scheme. Therefore, the troubleshooter may have to separately investigate client logs, server logs, network logs, CPU usage, etc.

### DESCRIPTION OF THE FIGURES

FIG. 1 is a block diagram depicting a system in which a slow data transfer may be investigated to find the bottleneck, in accordance with some embodiments.

FIG. 2 is a diagram illustrating states monitored in a state machine, in accordance with some embodiments.

FIG. 3 is a diagram of a system for narrowing the cause of a slow data transfer to one of multiple realms, in accordance with some embodiments.

FIG. 4 is a flow chart demonstrating a method of identifying a realm in which a data transfer operation is delayed or blocked, in accordance with some embodiments.

FIG. 5 depicts an apparatus for determining a location of a problem in a data transfer, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a system, methods, and apparatus are provided to identify the locus of a bottleneck in a slow (or stopped) data transfer operation. In these embodiments, the bottleneck is narrowed to one of three realms or domains—the receiver of the data, the sender of the data, and the communication link(s) over which the data are transferred. These embodiments are therefore well suited for use when one computing device or entity (e.g., a client device) is receiving or is supposed to receive data from another computing device or entity (e.g., a computer server) over some communication link or set of communication links (e.g., a network).

By quickly identifying the locus of the problem as being in one of these three realms, troubleshooting and/or remedial efforts can be better focused, instead of targeting myriad specific possibilities on multiple entities. Depending on the nature of the data transfer—whether it is pull-based or push-based, for example—different methods may be applied.

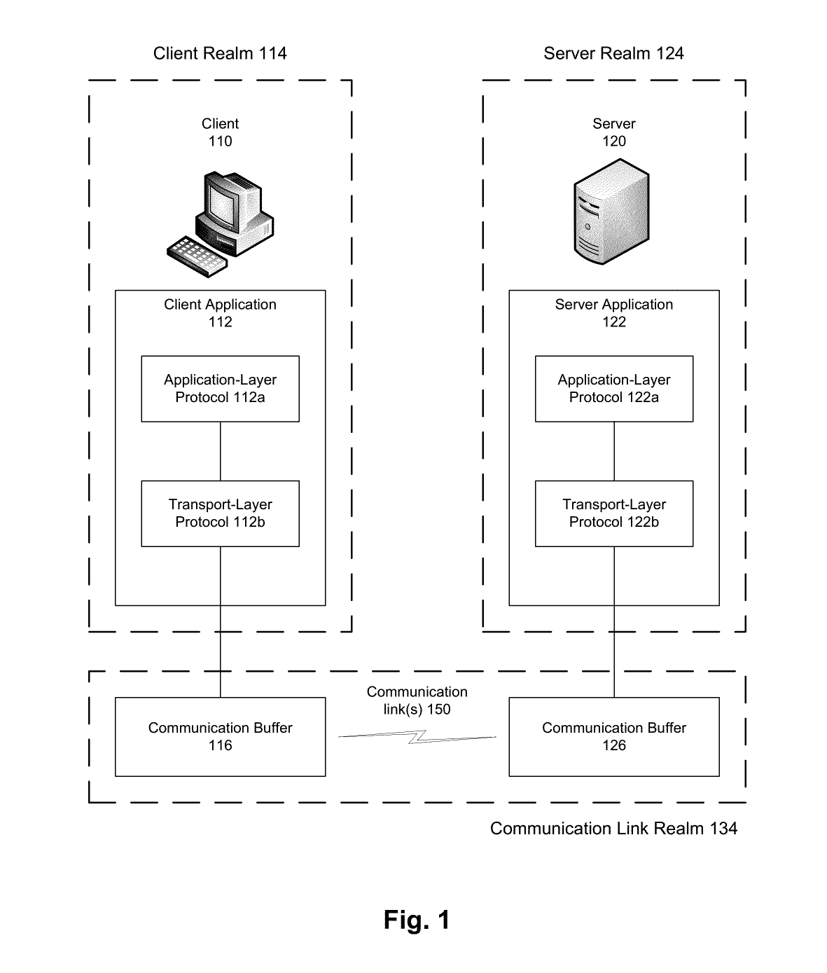

FIG. 1 is a block diagram of a system in which data may be transferred from one entity to another, and in which a slow data transfer may be investigated to find the locus or bottleneck, according to some embodiments.

In these embodiments, client 110 is (or will be) the recipient of a data transfer from server 120 and across communication link(s) 150. In other embodiments, the flow of data may be reversed or different computing entities may be involved (e.g., two servers, two peers in a peer-to-peer network).

Embodiments are described as they are implemented for protocol stacks that employ TCP (Transmission Control Protocol) as the transport layer protocol, but may be readily adapted for other transport layer protocols such as UDP (User Datagram Protocol). The application layer of client 110 and/or server 120 may feature a known protocol such as HTTP (Hypertext Transport Protocol), Secure HTTP (HTTPS), FTP (File Transfer Protocol), or a custom protocol specific to the application(s) that are transferring data. Also, the devices may execute Unix®-based or Linux®-based operating systems in embodiments described herein, but other operating systems may be in use in other embodiments.

A data transfer conducted between client 110 and server 120 may be pull-based, in which case the client device issues a request for data to the server and the responds with the requested data, or push-based, in which case the server sends data to the client without a specific request from the client. Thus, in the pull-based scenario, a request from client 110 precedes transmission of data from server 120, and a slow data transfer may reflect a delay in (or non-delivery of) the request (for a pull-based transfer) and/or the data response (for a pull-based or push-based transfer).

For a pull-based data transfer, an application-layer protocol or portion 112a of client application 112, which executes on client device 110, issues a call (e.g., a read( ) call) to a transport-layer protocol or portion 112b of application 112 to request data from server application 122, executing on server 120. From transport-layer protocol 112b, the request is passed via communication buffer 116 of client 110 and communication link(s) 150 to communication buffer 126 of server 120. From communication buffer 126, the request is received by server application 122 via transport-layer protocol or portion 122b and application-layer protocol or portion 122a of the application.

En route, the request may be logged at various points by various components. For example, it may be logged when dispatched from client application 112 (or a component of the application), when it is received at either or both communication buffers, and when it is received and/or consumed (i.e., acted on) by server application 122.

A push-based data transfer and the response to a pull-based data transfer request proceed in virtually the same manner, to deliver data identified by the server as appropriate to send to the client or data specifically requested by the client. Server application 122 (e.g., application-layer protocol 122a) issues a call (e.g., a write( ) call) to transfer a set of data. Transport-layer protocol 122b issues a corresponding system call (e.g., a send( ) call) to deliver the data to a network layer protocol (e.g., Internet Protocol or IP) and/or other lower protocol layers, which causes the data to be stored (at least temporarily) in communication buffer 126.

The data is then transmitted via communication link(s) 150 to communication buffer 116 of client device 110. Transport-layer protocol 112b receives the data (e.g., via a recv( ) system call), then application-layer protocol 112a receives the data via another call (e.g., a read( ) call) and delivers it to user space in memory.

As with the request from client 110 to server 120, the data transfer from server 120 to client 110 may be logged at any or all of multiple points. For example, the data may be logged when the server starts writing or transmitting it, when it finishes transmitting it, and when the client starts and/or finishes reading or receiving it, the server may log acknowledgements from the client (e.g., receipt of the first byte of data, receipt of the last byte of data), and/or the client may log an acknowledgement from the server (e.g., receipt of a pull-based request).

As shown in FIG. 1, the various elements and components involved in a data transfer between server 120 and client 110 may be divided into three realms for the purpose of identifying the bottleneck or locus of a problem in a slow data transfer. Client realm 114 includes most or all of application 112; server realm 124 includes most or all of application 122; communication link realm 134 includes communication link(s) 150 and the communication buffers of the client and server that transfer data to and from the communication link(s).

In one method of identifying a bottleneck in a slow data transfer, examination of communication buffer 116 (e.g., a receive buffer of a TCP socket on client 110) and communication buffer 126 (e.g., a send buffer of a TCP socket on server 120) may indicate which realm is the bottleneck in a slow push-based data transfer or possibly in a slow response to a pull-based data request (assuming the data request has been delivered to and accepted by server application 122).

This method stems from two observations. First, during a “normal” data transfer (a data transfer that is not delayed), the size of buffer 116 of client 110 will usually be zero or near zero, which indicates that the data receiver (e.g., client application 112) is operating fast enough to consume the data and transfer it to user space virtually as fast as it arrives. Second, during a normal data transfer, the size of buffer 126 of server 120 will usually be non-zero, meaning that the data producer (e.g., server application 122) is operating fast enough to meet the capabilities of the communication path to the client.

As a result of these two observations, the bottleneck in a slow push-based data transfer may be quickly identified by determining whether the sizes (e.g., average sizes over a time period) of buffers 116, 126 match their ideal or normal states (i.e., zero or near zero for buffer 116 and non-zero for buffer 126). In particular, if, during a slow data transfer, the size of receive buffer 116 is consistently greater than zero, this may indicate that the problem with the data transfer lies in client realm 114. For example, the client application may be too busy to retrieve data in a timely manner, there may be insufficient resources available (e.g., processor cycles, memory space), and so on.

Conversely, if the size of queue 116 is “normal,” but the size of send buffer 126 is consistently zero or near zero, the problem with the data transfer likely lies in server realm 124. For example, server 120 may be unable to quickly produce the data because it is over-committed from running too many applications, processes, or threads, the logic responsible for preparing (e.g., decorating) the data may be inefficient or slow, etc.

Finally, if a slow push-based data transfer (or a slow response to a pull-based data request) is observed, but buffers 116, 126 are of “normal” sizes, the bottleneck is likely within communication link realm 134. For example, a data link may be lossy or congested (or otherwise of poor quality), communication parameters may be poorly tuned, a wireless signal may be weak, etc.

In another method of identifying a bottleneck in a slow data transfer, a state machine is implemented to track the progress of a data transfer operation. This method is described as it is applied to troubleshoot a slow pull-based data transfer, but may be readily condensed for a push-based data transfer by focusing on the states associated with the response to a pull-based request.

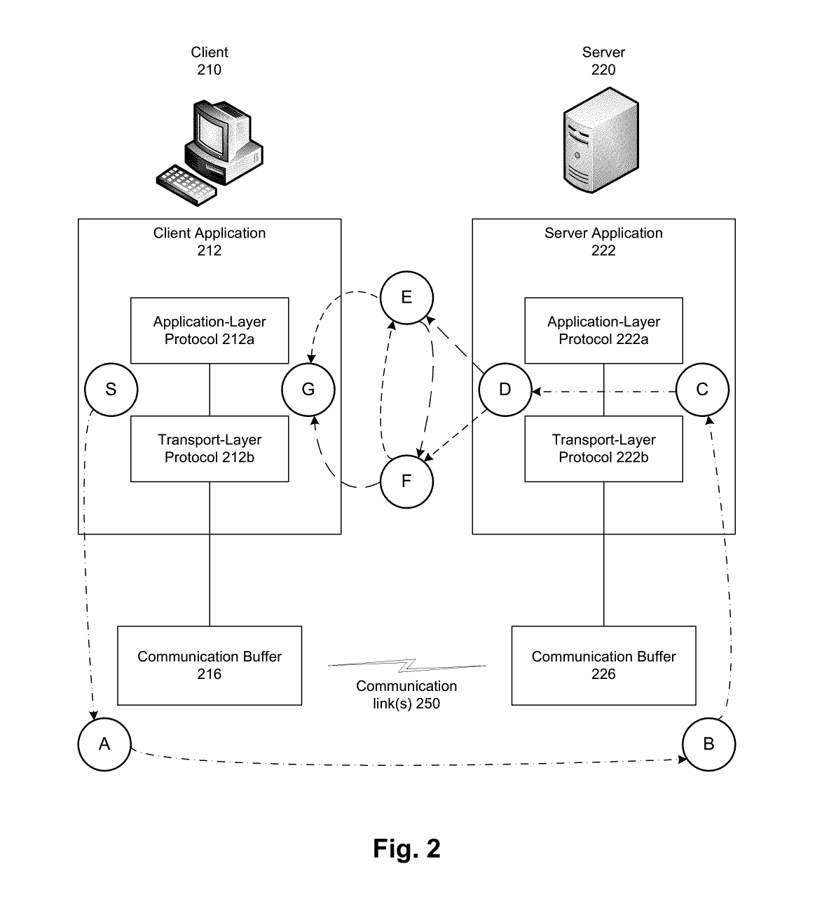

FIG. 2 is a diagram illustrating the states monitored in a state machine according to some embodiments. As described above, the state machine narrows the location of a problem in a data transfer operation to one of three realms: a sender realm that encompasses the sender or provider of the data (e.g., a server), a receiver realm that encompasses the recipient or receiver of the data (e.g., a client), and realm that encompasses the communication link(s) that convey the transferred data. In FIG. 2, the states are depicted with or near the component(s) whose action or actions cause a change from one state to another.

In these embodiments, a pull-based data transfer begins in state S when client 210 (e.g., application 212) issues a data request. When the client (e.g., application 212, application-layer protocol 212a, transport-layer protocol 212b) logs queuing of the request, the data transfer transitions from state S to state A (the request has been queued in the client's send buffer). When the client's send buffer is empty or there is some other indication that the request was transmitted from the client, the data transfer transitions from state A to state B (the request has been transmitted on communication link(s) 250). When receipt of the request is logged by server 220 (e.g., application 222, application-layer protocol 222a, transport-layer protocol 222b), the transfer transitions from state B to state C (the server application has received the request). A push-based data transfer may be considered to start at state C.

After the server prepares and sends a first portion of the data to be transferred (e.g., the first byte, the first packet), the data transfer operation transitions to state D (the data response is underway). Progress of the data transfer may now depend on the amount of data to be transferred and the speed with which it is conveyed by communication link(s) 250.

For example, if the amount of data being transferred is relatively large and/or the communication path is relatively slow, the data transfer transitions from state D to state E when the client logs receipt of the first portion of the data, transitions to state F when the server logs queuing/release of the last portion of the data, and terminates at state G when the client logs receipt of the last portion of the data. The lines with long dashes represent this chain of state transitions.

Or, if the amount of data is relatively small and/or the communication path is relatively fast, the data transfer transitions from state D to state F when the server logs queuing/release of the last portion of the data, transitions to state E when the client logs receipt of the first portion of the data, and terminates at state G when the client logs receipt of the last portion of the data. The lines with short dashes represent this chain of state transitions.

In some embodiments, instead of two different paths through states E and F, separate (mirrored) states may be defined that reflect the same statuses (i.e., client-logged receipt of first data, server-logged dispatch of final data). In these embodiments, therefore, there will be only one valid path through states E and F and through the two mirrored states, which could illustratively be represented as E′ and F′.

A state engine process or module is fed the necessary knowledge to monitor or identify the progress of a data transfer from start—at state S for a pull-based transfer or at state C for a push-based transfer—to finish (at state G). In some embodiments, this requires the operating systems of the two entities that are sharing data (e.g., client 210 and server 220 in FIG. 2) and the applications that use the data (e.g., client application 212, server application 222) to emit certain types of information at certain times.

In some specific embodiments, and as described above, a data recipient (e.g., the recipient's operating system and/or responsible application) logs events at one or more protocol layers, such as generation and dispatch of a data request, transmission of the request from the recipient machine or device, receipt of a first portion of data, and receipt of the last portion of the data. Similarly, the data provider (e.g., the provider's operating system and/or responsible application) logs events at one or more protocol layers, such as receipt of a data request, preparation of the data, dispatch of the first portion of the data, and dispatch of the final portion of the data.

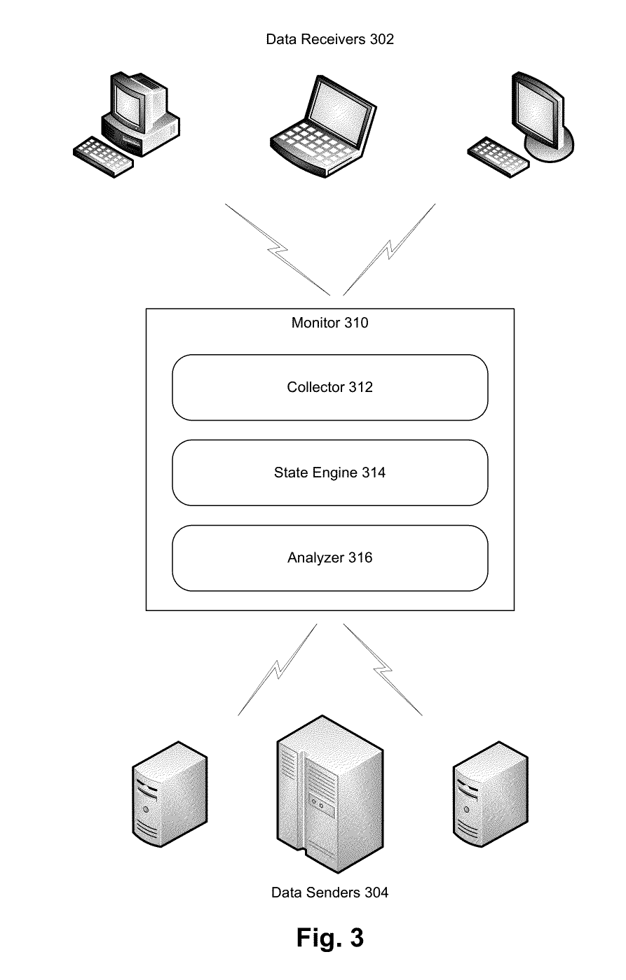

FIG. 3 is a block diagram of a system for narrowing the cause of a slow data transfer to one of three realms, according to some embodiments. As demonstrated in the preceding examples, the three realms may include a realm comprising the recipient of data, a realm comprising the sender of the data, and a realm comprising the communication link(s) for conveying the data. One or more of these realms may be divided in other embodiments.

The system of FIG. 3 includes data receivers 302, which include all types of devices that receive data, data senders 304, which include all types of entities that send data, and monitor 310. It may be noted that a given device (e.g., a computing device) may be a data sender or a data receiver at any given time, depending on the use of the device, the applications executing on the device, etc.

Collector 312 of monitor 310 receives or retrieves logs (or individual log entries), reports, transaction histories, queue/buffer sizes, protocol statistics/transactions, and/or other information from data senders 302 and data receivers 304. As described above, the information reveals the progress of data transfer operations (pull-type and/or push-type). The information may be provided by individual applications that produce or consume data, particular modules or protocol layers of such applications, operating system components that assist in the receipt or transmission of data (e.g., drivers, utilities, processes, threads), and/or other components.

State engine 314, drawing upon the information obtained by collector 312, identifies and/or tracks the progress of data transfer operations. For example, using states such as those described with reference to FIG. 2, the state engine may determine whether an operation completed, determine whether a particular state transition is delayed, calculate delays that occur or occurred between state transitions (e.g., using timestamps that accompany the information accumulated by collector 312), etc. State engine 314 and/or other elements of monitor 310 may operate in online and/or offline modes. Thus, state engine 314 may monitor the progress of a given data transfer operation in (near) real-time, or may trace the progress of (or determine the current state of) a previous data transfer operation at some later time (e.g., after a delay in the transfer is detected).

Analyzer 316 examines information obtained by collector 312 and/or observations of state engine 314 to determine whether a data transfer was delayed or obstructed and/or to identify the locus of a delayed or obstructed data transfer. For example, if operating in an online mode to monitor a data transfer operation in real-time or near real-time, analyzer 316 (or state engine 314) may compare durations of states of the monitored operation to benchmarks for the various states of the state model or, equivalently, compare delays between state transitions of the operation to benchmarks for such transitions. If a delay exceeds a corresponding benchmark, the operation may be deemed delayed or obstructed. Or, if operating in an offline mode to diagnose a data operation observed to be slow (or to never finish), analyzer 316 may determine which state transition or state transitions took too long. In either case, by identifying the state transitions at which the operations were delayed, the analyzer can easily identify the realm in which the delay or bottleneck occurred.

Collector 312 and/or analyzer 316 may also operate to assemble benchmarks for different state transitions and/or overall data transfer operations, for use in identifying delayed or obstructed transitions and/or transfers. For example, times elapsed between a given pair of consecutive state transitions may be observed for some number of data transfer operations that were not considered slow or delayed. The average elapsed time, or some other representative value (e.g., the median elapsed time, the maximum elapsed time) may be adopted as the benchmark for that pair of state transitions. Different benchmarks may be established for different applications, different environmental factors (e.g., time of day, amount of data being transferred)

Results generated by analyzer 316 and/or other elements of monitor 310 may be displayed on a display device for a human operator, may be transmitted to an operator via instant message, electronic mail, or other means, and may be logged or otherwise recorded on monitor 310 and/or other devices.

On individual data receivers and data senders, any suitable utilities or tools may be used to record useful information and to send it to monitor 310. For example, a given device may use the commands/utilities netstat and/or ss, with appropriate parameters. The netstat command yields statistics regarding network connections and network protocol statistics, such as the size of send queues and receive queues for TCP/IP sockets. The ss command yields various socket statistics, including queue sizes.

When information is collected by collector 312 (or by individual devices for use by collector 312), some restrictions or guidelines for collecting the information may be applied. For example, if queue sizes (e.g., for send and receive queues) cannot be provided or collected continuously for sockets being used for data transfer operations, such as when only instantaneous values can be obtained, the queue sizes must be observed multiple times during a data transfer operation so that multiple data points will be available, and over a sufficiently long period of time to make the information meaningful.

For example, uncharacteristic results may be observed if all the readings were obtained during just 5% or 10% of the duration of the operation. Also, to avoid generating excessive overhead (e.g., by consuming many processor cycles), it may be advisable to apply relatively generous delays between readings (e.g., 5 seconds, 10 seconds).

However, delays between invocations of netstat, ss, and/or other utilities or tools should be dynamic (i.e., not of fixed duration) in order to avoid accidental or coincidental synchronization with protocol operations. Otherwise, if an application was configured to read or write data every X seconds, and if a particular utility was invoked with the same periodicity, the results could be skewed. For example, if a utility for reading the size of a read queue was repeatedly invoked immediately after the corresponding application read from the queue (e.g., every X seconds), it may seem that the read queue was always empty.

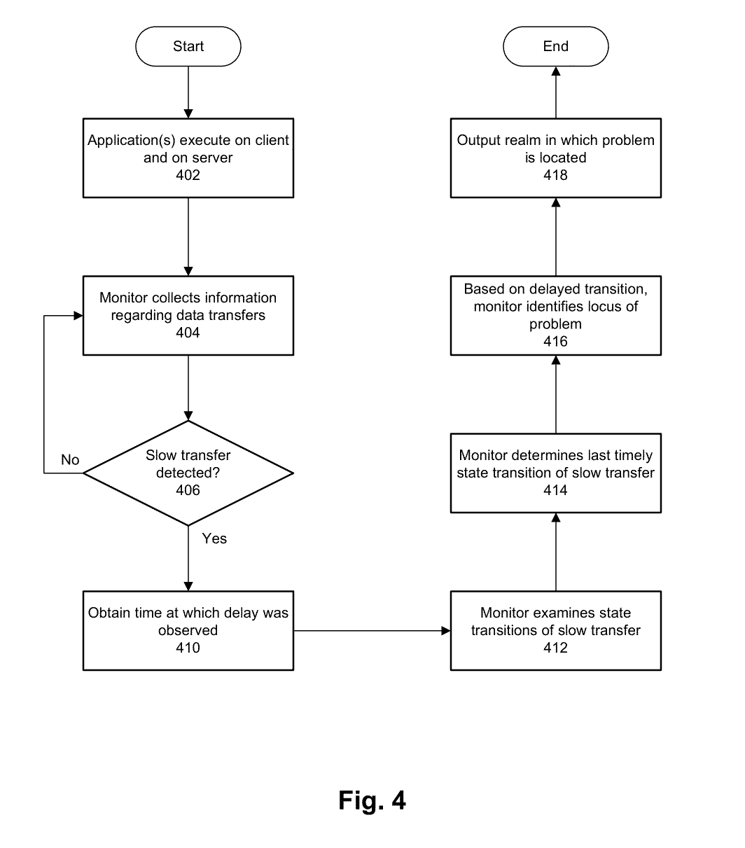

FIG. 4 is a flow chart demonstrating a method of identifying a realm in which a data transfer is delayed or blocked, according to some embodiments. The method of FIG. 4 is applied offline, that is, after detection of a slow (or stuck) data transfer. Other methods for online troubleshooting, to identify a slow data transfer operation in real-time or near real-time and the realm in which the operation is obstructed, may be derived from the illustrated method. Also, in other embodiments, operations described below may be performed in different orders without exceeding the scope of these embodiments.

In operation 402, a single application or multiple cooperative applications execute on a client (or other data receiver) and on a server (or other data sender) and feature transmission or transfer of data from the server to the client. For example, the client may be a computing device and the client application may be a web browser, while the server is a front-end server and the server application is a web server that sends data requested by the web browser. In another scenario, the client application may be a database client and the server application may be a database application. Virtually any client and server applications may be employed in different embodiments, as long as necessary information is produced or retrieved from them to enable determination of the status of a given data transfer.

In operation 404, the client and server produce information regarding one or more data transfers, which is collected by a monitor (e.g., a collection process). The monitor may be a separate entity (e.g., another computer server) and may be coupled to the client and the server by communication links that include some or all of the same communication links used to convey data from the server to the client.

In some other embodiments, however, the monitor is a software process executing on the same computing machine as the client or the server. For example, an organization that hosts the server and an application or service for which the client is receiving data may operate a data center that includes the server, the monitor, and possibly other resources.

The information may be streamed from the client and server, may be batched and transmitted periodically, or may be collected by the monitor in some other fashion.

In operation 406, if a slow data transfer is detected by a human operator, an analyst, a user, a process for tracking data transfer processes, or some other entity, the method advances to operation 410; otherwise, the method returns to operation 404 to continue collecting information for identifying and/or diagnosing slow transfers.

In some embodiments, a delay may be detected when an overall data transfer (e.g., not just a transition from one state to another) takes longer than a predetermined time (e.g., a benchmark) to complete and/or when it does not complete within the predetermined time. A transfer may be considered completed when the last of the data is received (e.g., when the transfer transitions to state G.

For example, the predetermined time may be the average time that elapsed in some number of past data transfers that were considered normal or successful (i.e., not delayed), or the maximum durations of those transfers, the median, etc. Different predetermined times may be applied for different data transfers, based on the amount of data being sent, identities of the client, the server, the communication link(s) (or communication method—such as wireless or wired), the application(s) in use, and/or other factors.

In operation 410, the time at which the delay in the data transfer is noted, or a time period during which the delay occurred or was detected. Because the illustrated method is used for offline troubleshooting, a human operator may, for example, receive a report of a data transfer that encountered a significant delay, or that unexpectedly ceased, at or about a specified or estimated time. Along with the time, other pertinent information may be provided, such as identities of the client and server, the application(s) involved, a query describing the data being transferred, and so on.

In operation 412, the monitor (e.g., an analysis module) operates to trace the affected data transfer or determine its status at the specified time. First, the transfer transaction may need to be identified, using the information obtained in operation 410, for example. Alternatively, the monitor may automatically identify some or all data transfers that were in progress at the specified time (e.g., those that were in some state other than state G), and determine which of them did not progress normally through the state transitions. As discussed above, benchmarks may be set to indicate normal, expected, or average times between state transitions, and the monitor may readily determine from the collected information which transfers did and did not progress satisfactorily (or were not progressing satisfactorily) at the identified time or during a time range that includes the identified time.

One or more data transfers that were slow to transition between successive states or that never transitioned from one state to the next may therefore be identified in operation 412 and, in operation 414, the monitor is able to identify the last state transition successfully or timely completed by a delayed (or stuck) transfer.

In operation 416, based on the last state transition completed successfully or normally during a delayed data transfer, the monitor may presume the likely cause of the delay or abnormal termination.

For example, once a pull-based data transfer begins in state S, if no transition to state A is detected (e.g., the client did not log dispatch of the request), the client may have failed to deliver the request from an upper-level protocol to a lower-level protocol, for example, or to place the request in a send queue. The locus of the problem is therefore in the client realm because the client application did not produce the request.

If a transfer successfully transitioned to state A, but never reached state B or was delayed in reaching state B (e.g., the corresponding send queue was never emptied), the request may not have been conveyed (or was conveyed slowly) over the communication link(s) coupling the client and the server. The locus of the problem is therefore in the communication link realm.

If the transfer does not transition, or transitions slowly, to state C (e.g., the server does not log receipt of the request), the server application may have never read the receive queue (or was significantly delayed in doing so). The locus of the problem is therefore in the server realm.

A failure to reach (or a delay in reaching) state D (e.g., the server application does not log dispatch of any portion of the data) may signify that the server was unable to (or slow to) identify, prepare, and/or send data responsive to the request (i.e., no write( ) call was issued). The locus of the problem is therefore in the server realm.

After successful/normal transition to state D, however, either of two different sequences of state transitions is possible, as shown in FIG. 2. Because the two possible subsequent states are in the client realm and the server realm, respectively, failure to progress past state D could implicate any of the three realms. However, instead of trying to determine which path should have been followed (e.g., by examining the amount of data being transferred, the communication link speeds, and/or other factors), the locus of the delay may be identified by examining the size of the client's receive buffer queue and the size of the server's send buffer queue.

If the length of the client receive buffer queue used for the transfer is non-zero, the client application is not consuming the transferred data from the network layer and the locus is the client realm. If the length of the server send buffer queue used for the transfer is zero, the server application is not dispatching the data to the networking layer for transmission and the locus is the server realm. If the client's receive buffer queue length is zero and the server's send buffer queue length is non-zero, then the locus is narrowed to the communication link realm.

It should be noted that multiple bottlenecks could occur for a given data transfer, at the same time and/or at different times. However, the monitor can track the progress of the transfer between states and during different time periods in order to isolate and identify the locus of each such bottleneck.

Finally, in operation 418 the monitor outputs the locus or realm of the problem on a display device (e.g., if a human operator invokes the monitor interactively), to a log file, in a message, or in some other way.

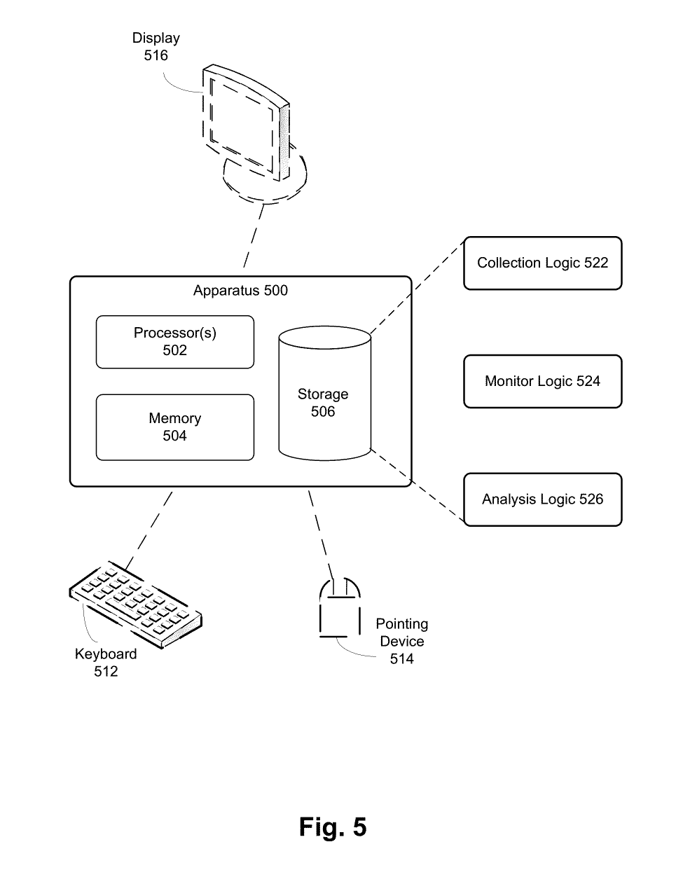

FIG. 5 depicts an apparatus for determining the locus or location of a problem in a data transfer, according to some embodiments.

Apparatus 500 of FIG. 5 includes processor(s) 502, memory 504, and storage 506, which may comprise one or more optical, solid-state, and/or magnetic storage components. Storage 506 may be local or remote to the apparatus. Apparatus 500 can be coupled (permanently or temporarily) to keyboard 512, pointing device 514, and display 516.

Storage 506 stores logic that may be loaded into memory 504 for execution by processor(s) 502. Such logic includes collection logic 522, monitor logic 524, and analysis logic 526. In other embodiments, these logic modules may be combined or divided to aggregate or separate their functionality as desired.

Collection logic 524 comprises processor-executable instructions for receiving or retrieving information regarding data transfer operations. This information, which may also be stored by apparatus 500 (e.g., in storage 506), reflects progress of the data transfer operations as requests are submitted by an application executing on a data receiver, conveyed to a data sender, and received by an application executing on the data sender (for pull-based data requests), and as data are prepared and dispatched by a data sender, transmitted toward a data receiver, and consumed by the data receiver (for pull-based and push-based data transfers).

Depending on the applications that generate and consume the data, the communication protocols used by the data receiver and data sender, the communication links that couple the data receiver and the data sender, and/or other factors, different types of information may be collected in different embodiments and environments. Any suitable tools/utilities now known or hereafter developed that produce statistics or other data that reflect the progress of data transfer operations may be invoked by collection logic 522 or may produce the information that is collected by collection logic 522.

Monitor logic 524 comprises processor-executable instructions for tracing, tracking, or otherwise determining the progress of a data transfer operation. In some embodiments, the logic includes a state machine that represents the status of an operation as one of multiple states, such as the states described above with reference to FIG. 2. Using information collected by collection logic 522, monitor logic 524 can determine which state a given data transfer operation is in, can determine whether an operation has been delayed from transitioning to a next state, can identify some or all data transfer operations that are or were delayed (or aborted) at a specified time or within a specified interval of time, and may otherwise operate to help determine where an operation is stuck.

Analysis logic 526 comprises processor-executable instructions for determining the locus, realm, or location of a problem with a data transfer operation (e.g., a bottleneck). In some embodiments, the locus, realm, or location is one of three realms, encompassing a data receiver, a data sender, and a communication link or communication links coupling the receiver and sender, respectively, using monitor logic 524 (or data produced by monitor logic 524).

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method of identifying a locus of a slow data transfer between a first computing device and a second computing device, the method comprising:
for one or more of the first computing device and the second computing device:
obtaining statistics of an operating system executing on the device and an application for transferring data between the first computing device and the second computing device;
detecting a slow data transfer between the first computing device and the second computing device via a communication link; and
without identifying a cause of the slow data transfer, identifying one of the first computing device, the second computing device, and the communication link as the bottleneck in the slow data transfer.

2. The method of claim 1, further comprising:
defining multiple states of a model data transfer; and
defining transitions among the multiple states, said transitions driven by the obtained statistics.

3. The method of claim 2, wherein said detecting comprises:
for each of one or more states of the model data transfer, determining corresponding benchmark durations of the states; and
comparing observed durations of one or more states of a first data transfer with corresponding benchmark durations;
wherein the first data transfer is determined to be a slow data transfer if an observed duration of at least one state of the first data transfer is longer than the corresponding benchmark duration.

4. The method of claim 2, wherein said identifying the bottleneck comprises:
identifying a time associated with the detection of the slow data transfer; and
identifying a state of the slow data transfer at the identified time.

5. The method of claim 1, wherein said detecting comprises:
from multiple completed data transfers, determining a benchmark duration of a model data transfer; and
comparing an observed duration of a first data transfer with the benchmark duration;
wherein the first data transfer is determined to be a slow data transfer if the observed duration of the first data transfer is longer than the benchmark duration.

6. The method of claim 1, wherein said identifying comprises:
comparing a size of a receive buffer queue on the first computing device to a model receive buffer queue size associated with a normal data transfer; and
comparing a size of a send buffer queue on the second computing device to a model send buffer queue size associated with a normal data transfer.

7. The method of claim 6, wherein said identifying further comprises:
if the size of the receive buffer queue matches the model receive buffer queue size and the size of the send buffer queue does not match the model send buffer queue size, selecting the second computing device as the bottleneck;
if the size of the send buffer queue matches the model send buffer queue size and the size of the receive buffer queue does not match the model receive buffer queue size, selecting the first computing device as the bottleneck; and
if the size of the receive buffer queue matches the model receive buffer queue size and the size of the send buffer queue matches the model send buffer queue size, selecting the communication link as the bottleneck.

8. The method of claim 6, wherein:
the model receive buffer queue size is zero; and
the model send buffer queue size is non-zero.

9. The method of claim 1, further comprising:
operating a monitor device separate from the first computing device and the second computing device;
wherein the monitor device performs said obtaining, said detecting, and said identifying.

10. The method of claim 1, wherein said obtaining, said detecting, and said identifying are performed by a monitor process executing on one or both of the first computing device and the second computing device.

11. An apparatus for identifying a locus of a slow data transfer between a first computing device and a second computing device, comprising:
one or more processors; and
a memory storing instructions that, when executed by the one or more processors, cause the apparatus to:
for one or more of the first computing device and the second computing device:
obtain statistics of an operating system executing on the device and an application for transferring data between the first computing device and the second computing device;
detect a slow data transfer between the first computing device and the second computing device via a communication link; and
without identifying a cause of the slow data transfer, identify one of the first computing device, the second computing device, and the communication link as the bottleneck in the slow data transfer.

12. The apparatus of claim 11, wherein the memory further comprises instructions that, when executed by the one or more processors, causes the apparatus to:
define multiple states of a model data transfer; and
define transitions among the multiple states, said transitions driven by the obtained statistics.

13. The apparatus of claim 12, wherein said detecting comprises:
for each of one or more states of the model data transfer, determining corresponding benchmark durations of the states; and
comparing observed durations of one or more states of a first data transfer with corresponding benchmark durations;
wherein the first data transfer is determined to be a slow data transfer if an observed duration of at least one state of the first data transfer is longer than the corresponding benchmark duration.

14. The apparatus of claim 12, wherein said identifying the bottleneck comprises:
identifying a time associated with the detection of the slow data transfer; and
identifying a state of the slow data transfer at the identified time.

15. The apparatus of claim 11, wherein said detecting comprises:
from multiple completed data transfers, determining a benchmark duration of a model data transfer; and
comparing an observed duration of a first data transfer with the benchmark duration;
wherein the first data transfer is determined to be a slow data transfer if the observed duration of the first data transfer is longer than the benchmark duration.

16. The apparatus of claim 11, wherein said identifying comprises:
comparing a size of a receive buffer queue on the first computing device to a model receive buffer queue size associated with a normal data transfer; and
comparing a size of a send buffer queue on the second computing device to a model send buffer queue size associated with a normal data transfer.

17. The apparatus of claim 16, wherein said identifying further comprises:
if the size of the receive buffer queue matches the model receive buffer queue size and the size of the send buffer queue does not match the model send buffer queue size, selecting the second computing device as the bottleneck;
if the size of the send buffer queue matches the model send buffer queue size and the size of the receive buffer queue does not match the model receive buffer queue size, selecting the first computing device as the bottleneck; and
if the size of the receive buffer queue matches the model receive buffer queue size and the size of the send buffer queue matches the model send buffer queue size, selecting the communication link as the bottleneck.

18. The apparatus of claim 16, wherein:
the model receive buffer queue size is zero; and
the model send buffer queue size is non-zero.

19. A system for identifying a locus of a slow data transfer between a first computing device and a second computing device, comprising:
a collection module comprising a first non-transitory computer-readable medium storing instructions that, when executed, cause the system to, for one or more of the first computing device and the second computing device:
obtain statistics of an operating system executing on the device and an application for transferring data between the first computing device and the second computing device;
a monitor module comprising a second non-transitory computer-readable medium storing instructions that, when executed, cause the system to:
in response to detection of a slow data transfer between the first computing device and the second computing device via a communication link, identify a state of the slow data transfer among multiple defined states; and
an analysis module comprising a third non-transitory computer-readable medium storing instructions that, when executed, cause the system to:
without identifying a cause of the slow data transfer, identify one of the first computing device, the second computing device, and the communication link as the bottleneck in the slow data transfer.

20. The system of claim 19, wherein said identifying comprises:
comparing a size of a receive buffer queue on the first computing device to a model receive buffer queue size associated with a normal data transfer;
comparing a size of a send buffer queue on the second computing device to a model send buffer queue size associated with a normal data transfer;
if the size of the receive buffer queue matches the model receive buffer queue size and the size of the send buffer queue does not match the model send buffer queue size, selecting the second computing device as the bottleneck;
if the size of the send buffer queue matches the model send buffer queue size and the size of the receive buffer queue does not match the model receive buffer queue size, selecting the first computing device as the bottleneck; and
if the size of the receive buffer queue matches the model receive buffer queue size and the size of the send buffer queue matches the model send buffer queue size, selecting the communication link as the bottleneck.
